(19) United States
(12) Patent Application Publication
(10) Pub. No.: US 2008/0266709 A1
(43) Pub. Date: Oct. 30, 2008

(54) Recording and/or Playback Device Comprising Multiple Magnetic Heads With Azimuth Gaps

(76) Inventors: Jean-Baptiste Albertini, Crolles (FR); Pierre Gaud, Coublevie (FR)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/718,477

(22) PCT Filed: Nov. 2, 2005
(86) PCT No.: PCT/FR05/50919

§ 371 Date: May 2, 2007

(30) Foreign Application Priority Data
Nov. 4, 2004 (FR) 0452527

(51) Int. Cl. G11B 5/33; G11B 5/29

(52) U.S. Cl. 360/110; 29/603.18

(57) ABSTRACT

A recording and/or read device of a magnetic medium with magnetic tracks, including plural magnetic heads each including a pair of polar parts separated by an amagnetic head gap. These pairs of polar parts are grouped on at least one support with a non zero tilt angle between ±90° from the tracks, all head gaps of the pairs of polar parts in the support having the same azimuth angle, between ±90° excluding limits from a direction normal to the support.

### TECHNICAL DOMAIN

The purpose of this Invention is a recording and/or read device with multiple magnetic heads and azimuth-controlled head gaps, and a method of making such a device.

This device with multiple magnetic heads is used in applications for magnetic recording and/or reading of data on any recording medium, either magnetic or magneto-optic, and especially on magnetic tape. The term magnetic medium is used in the remainder of this description to include magnetic media and magneto-optic media. Similarly, when the term magnetic tracks is used, this term should include tracks on a magnetic medium and tracks on a magneto-optic medium.

### STATE OF PRIOR ART

Note that at the moment magnetic tape is the most suitable information medium for compact storage of large quantities of information, typically of the order of a terabyte (1 terabyte=63² bytes=8 63² bytes) or more. Final applications of storage on magnetic tape are typically archiving and backup of computer data and more generally digital data. For example, these data may include data from databases, digitised films, audio and computer files often from computers or digital equipment such as camcorders, VCRs or servers. These data are often called <<multimedia>> and may be used industrially, professionally or by the general public.

Some types of recordings on magnetic media include:
linear recording in which a fixed set of multiple magnetic heads writes and reads several magnetic tracks in parallel on a linearly scrolling magnetic tape,
helical recording in which one or several pairs of magnetic heads installed on a cylindrical drum rotating at high speed, write and read magnetic tracks in the form of portions of spirals on a magnetic tape advancing and winding slowly and sliding around the drum,
magneto-optic recording in which a set of magnetic heads writes tracks on a medium, reading being done by a laser beam directly or indirectly detecting magnetisation of previously written bits by a Kerr or Faraday effect.

The invention may apply to linear recording, helical recording or magneto-optic recording.

FIG. 1 shows a diagrammatic view of a recording and/or read device according to prior art. A strip 1 of magnetic heads 3 at a spacing of a pitch D is arranged along a generating line on a fixed cylindrical support 2 (drum). Each magnetic head 3 comprises two polar parts 3.1, 3.2 separated by an amagnetic head gap 3.3. In the following, the term head gap for a pair of polar parts refers to the head gap separating two polar parts in a pair. The magnetic recording medium 4 to be read or recorded moves linearly close to the strip 1. This type of recorder has the advantage that it is mechanically relatively simple (fixed or slightly mobile magnetic heads) and due to its multiple magnetic heads, can carry high speed data flows.

However, it is not optimised in terms of recording density. The fact of having a relatively large pitch D between magnetic heads 3 in the standard configuration due to the size of the magnetic circuit and recording and/or read means makes it necessary:
firstly, to have a <<winding>> recording, in other words a large number of to and fro movements to record the entire magnetic medium 4 with tracks 5 at a pitch T′ smaller than the pitch D,
secondly, considering problems with following the track 5 and temperature variations that can arise, to have a large space 6 between tracks 5 (called the inter-track distance), causing loss of space.

Furthermore, tracks 5 recorded in a single pass are at a relatively large distance, consequently simultaneous reading of these tracks 5 at a relatively large spacing is penalised by the mechanical flexibility of the recording magnetic medium 4 that can cause read errors related to poor alignment of bits on these tracks.

U.S. Pat. No. 5,452,165 divulges a device for recording and/or reading a magnetic medium with magnetic tracks. Several pairs of polar parts are supported on a given support. Two pairs of arbitrary successive polar parts have equal and opposite non-zero azimuth angles between ±90°, excluding limits. The support has a given tilt angle (non-zero and not equal to 90°) from the tracks. Furthermore, the track widths are not equal, so that the amplitudes of electrical signals recorded on successive tracks are different. Read errors can occur.

The method proposed in this patent to determine the azimuth angle does not allow perfect definition and reproducibility of this angle, which is possible with this invention.

Patent application FR-A-2 774 797 also divulges a recording and/or read device with multiple azimuth-controlled magnetic heads. This device comprises several assembled supports on which magnetic heads are distributed. This device does not allow the supports to have a tilt angle from the tracks. Therefore, it cannot be used to make <<massively parallel>> magnetic heads since manufacturing of magnetic heads to read or write n tracks requires n assembled supports which in practice limits n to 2, 3 or 4 for efficiency reasons. Constraints during assembly lead to weakening of the recording and/or read device.

Furthermore, this device does not include any magnetic heads cooperating with overlapping tracks, as is done at the moment in the industry because the distance normal to the supports between two pairs of polar parts belonging to two consecutive supports is greater than or equal to zero. This configuration does not allow the recording and/or read device to adapt to a variety of recording standards.

### PRESENTATION OF THE INVENTION

The purpose of this invention is to describe a device with multiple magnetic heads for recording and/or reading that does not have the disadvantages mentioned above.

One purpose of the invention is to record and/or read the magnetic recording medium in a limited number of passes due to the high degree of parallelism of the multiple magnetic heads in the device.

Another purpose of the invention is to obtain good alignment precision of the magnetic head with respect to the tracks to eliminate problems that arise while reading and to give good precision of the azimuth angle and the width of polar parts that control recording and reading on magnetic tracks with precise width and positioning, during industrial manufacturing in mass production.

Another purpose of the invention is to increase recording densities while reducing track and inter-track widths.

Another purpose of the invention is to facilitate following tracks on the magnetic recording medium.

The manufacturing method enables better control of key parameters of the recording and/or read device in mass production, than is possible with existing methods.

Therefore, in particular it can increase the number of magnetic heads capable of operating in parallel and produce them at a competitive cost with good efficiencies.

To achieve this, this invention relates to a device for recording and/or reading a magnetic medium with magnetic tracks. It comprises several magnetic heads each comprising a pair of polar parts separated by an amagnetic head gap. These pairs of polar parts are grouped on at least one support with a non-zero tilt angle between ±90° with respect to the tracks, all head gaps of pairs of polar parts on the support being at the same azimuth angle between ±90° excluding limits from a direction normal to the support.

It is advantageous if the device comprises at least two consecutive supports, such that when they are parallel, they define an inter-polar part distance d between the planes of faces facing polar parts located on the two consecutive supports.

This inter-polar part distance d is such that P+d=(D+nT)·tan(θ) where θ is the tilt angle of the supports with respect to the tracks, T is the longitudinal pitch of head gaps of pairs of polar parts placed on a same support, D is the longitudinal offset with respect to the supports between two pairs of consecutive polar parts placed on two consecutive supports, P is the width of polar parts and n is an integer number.

Magnetic shielding and/or magnetoresistive read means may be placed between the two supports in a space corresponding to the inter-polar part distance.

In one variant in which inscribed signal bits can be orthogonal to the tracks, the azimuth angle and the tilt angle are equal in modulus or in absolute value.

In another embodiment, the azimuth angle and the tilt angle are different, so that azimuth bits may be recorded and/or read on the magnetic medium.

When the device comprises several supports, these supports may be superposed.

When it comprises at least two consecutive supports, they may be at different tilt angles.

The azimuth angles of head gaps of pairs of polar parts of one of the supports may then be different from the azimuth angles of pairs of polar parts on the other support.

Advantageously, two pairs of polar parts belonging to different supports, for example consecutive supports, cooperate with two consecutive magnetic tracks to read them or to record them.

The device may comprise at least one block of at least one support for recording and at least one block of at least one support for reading, these blocks being placed one after the other in the direction of the tracks.

As a variant, the device may comprise at least one block of one or several supports for recording and at least one block of one or several supports for reading, the supports of these blocks being fixed to each other.

Each track may be recorded and read by a pair of polar parts, the pair of polar parts for recording and the pair of polar parts for reading belonging to different supports.

To prevent risks of crosstalk, a block for reading may be separated from a block for recording by a shielding screen.

The device comprises a magnetic circuit for each magnetic head integrating a pair of polar parts and possibly a magnetic flux guide, this magnetic circuit cooperating with recording and/or read means. In this context, a magnetic flux guide may be composed of several parts: the core of a solenoid, winding, pads, a rear magnetic part and a magnetoresistive sensor flux guide.

Recording and/or read means may be inductive or magnetoresistive.

Signal processing means may cooperate with recording and/or read means.

This invention also relates to a method of making a device for recording and/or reading on a magnetic recording medium with magnetic tracks that comprises the following steps:

on at least one substrate, production of several pairs or polar parts of magnetic heads, these polar parts being separated by an amagnetic head gap, the head gaps of these pairs of polar parts all having the same azimuth angle between ±90° from the direction normal to the substrate, excluding limits;

production of recording and/or read means and possibly magnetic flux guides each capable of cooperating with a pair of polar parts;

treatment of the substrate such that it has a non-zero tilt angle from the magnetic tracks equal to between ±90,

The recording and/or read means and possibly the magnetic flux guides may be made on at least one additional substrate that is assembled after positioning with the substrate supporting the pairs of polar parts.

As a variant, the recording and/or read means and the magnetic flux guides if any, may be made on the substrate supporting the pairs of polar parts.

The treatment may consist of grinding the substrate(s).

As a variant, the treatment may consist of installing one or several parts of the substrate(s) or the substrate(s) in a given mechanical support.

When there are several substrates supporting pairs of polar parts, these substrates are assembled after alignment.

A layer of electrically insulating material or shims can be inserted between two consecutive substrates supporting pairs of polar parts, this layer can possibly include magnetoresistive read means and/or a magnetic shielding screen.

The method may consist of making pairs of magnetic connection pads on a substrate, that would be used each to magnetically connect a flux guide or a recording means and/or a read means to a pair of polar parts supported on an identical or a different substrate.

Two substrates are preferably assembled after turning one of them over so that the worked faces face each other.

A step may be included to thin at least one of the substrates before and/or after assembly.

The substrates may have different tilt angles, and in this case the azimuth angle of the head gaps of the pairs of polar parts of one substrate is different from the azimuth angle of the head gaps of the pairs of polar parts of the other substrate.

A pair of polar parts can be made by anisotropically etching a first caisson in the substrate forming an amagnetic layer on the substrate, filling the first caisson with magnetic material, isotropically etching a second caisson adjacent to the first caisson, and filling the second caisson with magnetic material.

When there are several substrates supporting pairs of polar parts, pairs of caissons can be made by isotropic etching in the substrate that will hold the pairs of magnetic pads, and the pairs of caissons can be filled with a magnetic material, to make pairs of magnetic pads.

The surface may be levelled after any one of the magnetic material filling steps has been done.

The substrate supporting pairs of polar parts may be formed from an electrically insulating material located between two layers, in which the layer supporting the caissons is monocrystalline, the other possibly being partially or totally eliminated later on.

As a variant, the substrate supporting pairs of polar parts may be formed from a layer of electrically insulating material located between the layer of wear resistant material and the layer of monocrystalline material comprising the caissons.

The assembly may be made by gluing, by direct bonding, by anodic assembly or by fusible bumps.

The additional substrate within which the recording and/or read means and the magnetic flux guides if any are located, may possibly be multi-layer with a layer of electrically insulating material.

As a variant, the additional substrate within which the recording and/or read means are located, and the magnetic flux guides if any may include a layer made from a wear resistant material possibly covered by an electrically insulating material.

Furthermore, the method comprises a step to make signal processing means (for example preamplifiers, multiplexers, demultiplexers) that cooperate with the recording and/or read means.

### BRIEF DESCRIPTION OF THE FIGURES

This invention will be better understood after reading the description of example embodiments given purely for information and that is in no way limitative, with reference to the appended figures, wherein:

FIG. 1 (already described) shows a linear recording and/or read device according to prior art;

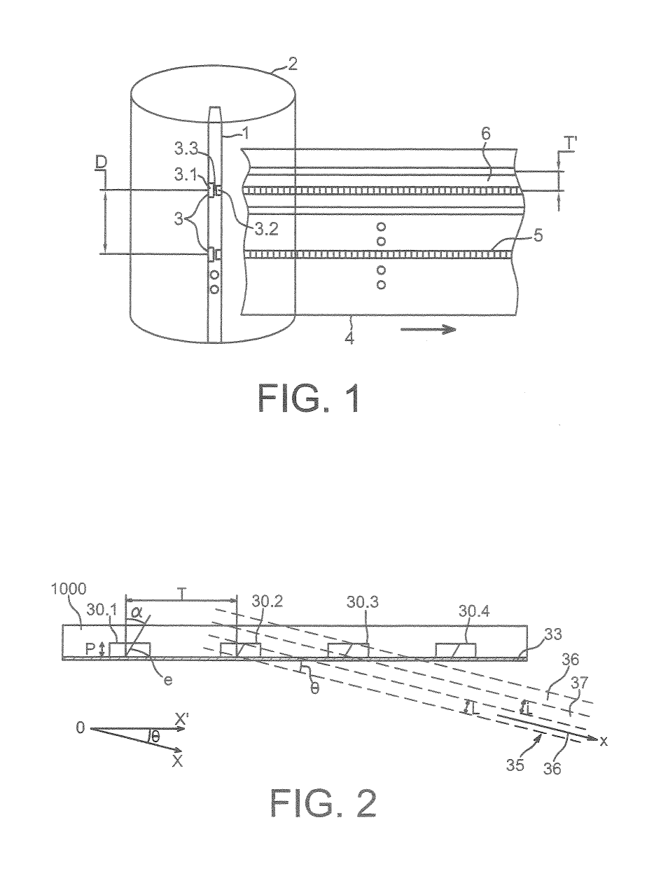

FIG. 2 shows an example of a recording and/or read device conforming with the invention;

FIGS. 3A, 3B, 3C show three other examples of a recording and/or read device conforming with the invention;

FIG. 4 shows another example of a recording and/or read device conforming with the invention in which the pairs of polar parts are distributed on each side of an insulating layer of a support;

FIGS. 5A and 5B show a three-dimensional view of a recording and/or read device according to prior art and a recording and/or read device conforming with the invention;

FIGS. 6A to 6E show steps in manufacturing pairs of polar parts and rear closing parts of the magnetic circuit of a recording and/or read device conforming with the invention;

FIGS. 7A to 7E show steps in manufacturing the remaining part of the magnetic circuit and recording and/or read means of a recording and/or read device conforming with the invention;

FIGS. 8A, 8B show assembly and finishing steps for the structures in FIGS. 6D and 7E;

FIG. 9 illustrates grouping of two groups of magnetic heads on a given mechanical support, these groups of magnetic heads having the same tilt angle with respect to the tracks of the magnetic recording medium;

FIG. 10 shows a recording and/or read device according to the invention comprising recording heads and read heads placed alternately;

FIGS. 11A to 11D show steps in manufacturing pairs of polar parts of recording heads in FIG. 10;

FIGS. 12A to 12D snow steps in manufacturing of pairs of polar parts of read heads in FIG. 10 and assembly and finishing of these pairs of polar parts with those shown in FIG. 11D;

FIGS. 13A and 13B show steps in manufacturing of the magnetic circuit and recording and/or read means of a recording and/or read device according to the invention;

FIGS. 14A and 14B show steps in assembly and finishing of the structure in FIG. 12D with the structure in FIG. 13B, FIG. 14C showing another variant of a read device according to the invention;

FIG. 15 shows another variant of a device according to the invention.

Identical, similar or equivalent parts of the different figures described below have the same numerical references so as to facilitate the transfer from one figure to the next.

The different parts shown in the figures are not necessarily all at the same scale, to make the figures more easily understandable.

### DETAILED PRESENTATION OF PARTICULAR EMBODIMENTS

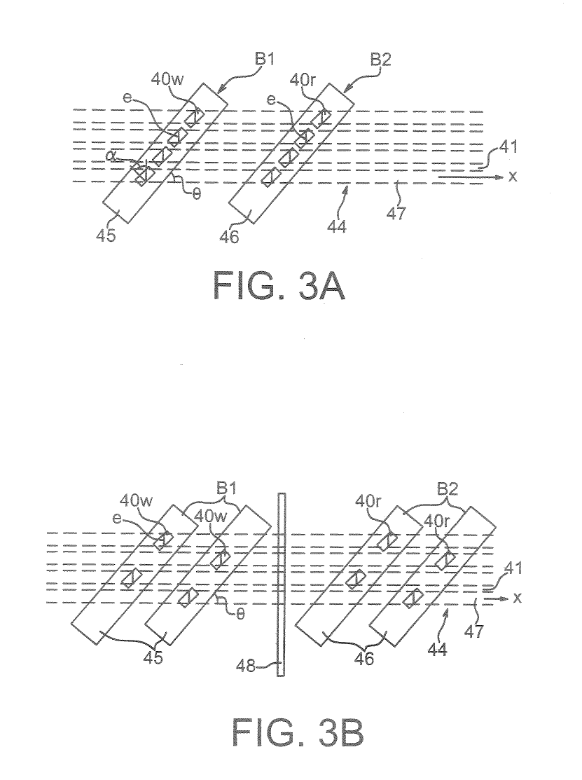

We will now describe an example of a recording and/or read device according to the invention with reference to FIG. 2.

This device will be used for recording and/or reading information on tracks 36 carried by a magnetic recording medium 35. This magnetic recording medium 35 is shown as a tape, but other forms are possible, for example a disk.

Note that a magnetic head conventionally comprises a magnetic circuit closing magnetic flux and terminating on a pair of polar parts separated by an amagnetic head gap. This magnetic circuit may include a magnetic flux guide in addition to the pairs of polar parts. The magnetic flux guide is missing in some configurations, and the shape of the pairs of polar parts is appropriate to obtain this magnetic flux guide function.

Recording and/or read means cooperate with the magnetic circuit, possibly there is at least one winding that surrounds the magnetic circuit for inductive recording and/or read heads, or at least a magnetoresistance for magnetic read heads. This magnetoresistance may be inserted in the magnetic circuit at a head gap in this circuit. It may advantageously be in the form of a rod made from a Giant Magnetoresistance GMR or a tunnel magnetoresistance TMR. In the absence of a flux guide, the magnetoresistance cooperates with a pair of polar parts.

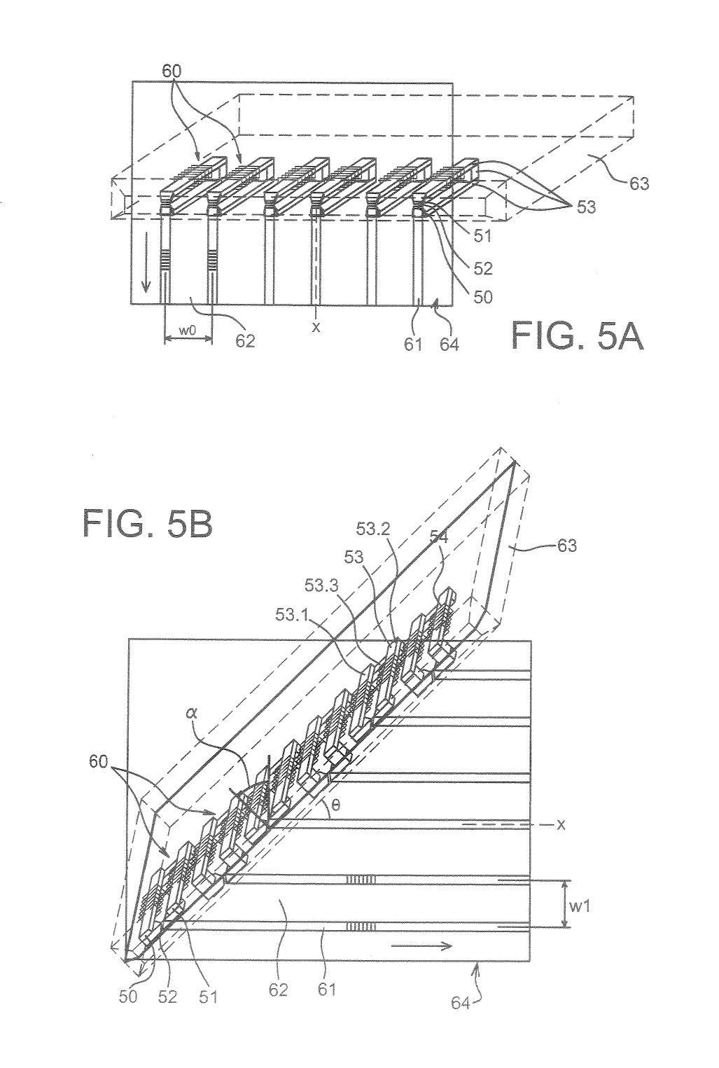

The device according to the invention comprises several magnetic heads 30.1 to 30.4 that are each materialised in FIG. 2, by a pair of polar parts separated by an amagnetic head gap e. The device also comprises at least one support 1000 and pairs of polar parts of magnetic heads 30.1 to 30.4 are distributed one after the other, aligned on this support 1000. In one example described later in FIG. 4, the two supports 1000, 1001 are shown and are assembled to each other. Obviously, more than two supports assembled to each other could be envisaged after precise positioning.

The support 1000 is approximately plane, the pairs of polar parts 30.1 to 30.4 of the magnetic heads are supported on a main face of the support that is approximately plane.

When the device according to the invention comprises at least two parallel supports 1000, 1001 as shown in FIG. 4, there is at least one inter-support layer 33 that separates the levels of pairs of polar parts by a well-adjusted distance d. This distance d is measured between face planes, facing the polar parts on two consecutive supports. This inter-support layer 33 may advantageously be provided with the magnetic shielding to avoid crosstalk problems between magnetic heads located on different supports. It may also include magnetoresistive read means.

The azimuth of magnetic heads (or pairs of polar parts) is controlled, and on a given support, all pairs of polar parts have a read gap e with the same azimuth angle α between ±90° excluding limits from a direction normal to the support 1000.

A zero azimuth angle α is perpendicular to the main face of the support 1000, and an azimuth angle α equal to ±90° would be parallel to the main face of the support 1000. Typically, the azimuth angle α is less than or equal to ±45°.

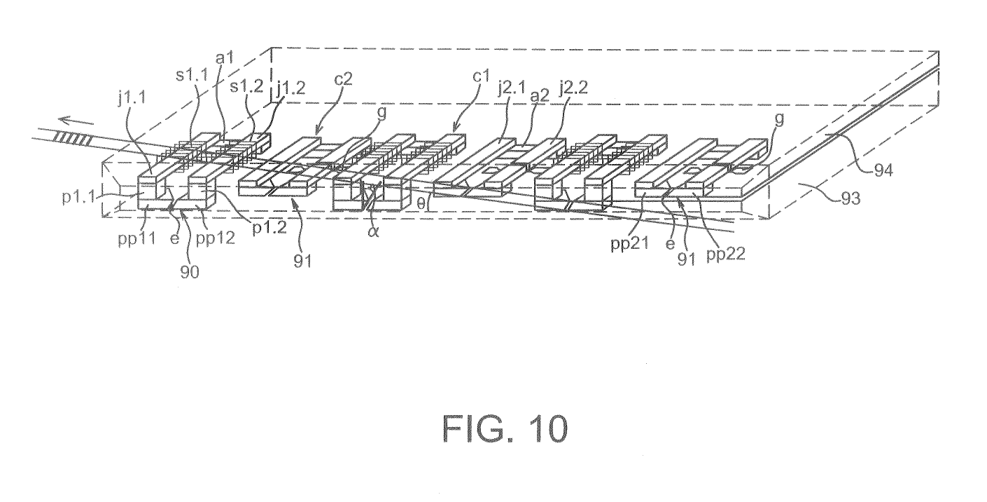

For each pair of polar parts, a magnetic flux guide and/or a magnetoresistive element (not visible in FIG. 2 but visible in FIG. 10) may be supported on a main face of a support 1000, possibly in an insulating layer 33 close to the pair of polar parts concerned. In the recording and/or read device according to the invention, the functional faces of the polar parts (perpendicular to the main faces of the initial supports) come into contact with the magnetic recording medium, and will appear after cutting out the chips (or blocks) in the support.

Each magnetic head will cooperate with the magnetic recording medium 35 approximately parallel to the functional faces of the polar parts and therefore approximately perpendicular to the main face of the support 1000.

This magnetic medium 35 comprises a large number of parallel magnetic recording tracks 36 on which the magnetic heads 30.1 to 30.4 will write or read information in the form of a sequence of bits. These tracks 36 have a general direction x and a tilt angle θ from the main surface of the support 1000 (or relative to the length of the magnetic heads 30.1 to 30.4). In other words, the support 1000 is at a tilt angle θ with respect to the tracks 36. This tilt angle θ is non-zero and is between ±90°.

When the recording and/or read device comprises several assembled supports 1000, 1001, these supports may have the same tilt angle θ from the general direction x of the magnetic recording tracks 36. This tilt angle θ may for example be obtained by appropriate mechanical machining of the support 1000.

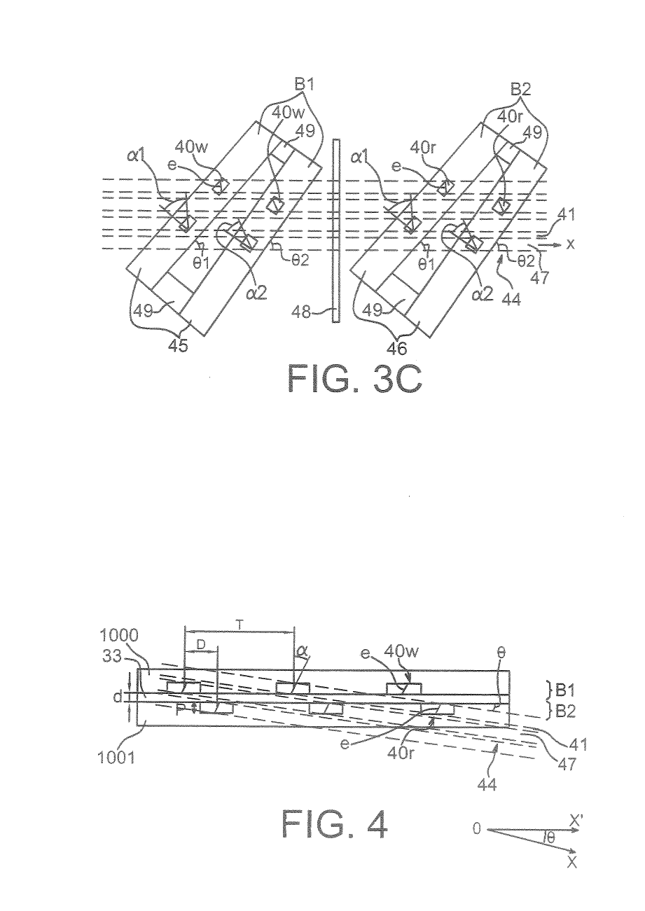

However, as shown in FIG. 3C, it is possible to provide an assembly of several supports, including at least two consecutive supports with different tilt angles θ1, θ2.

The tracks 36 are not necessarily adjacent and they may be separated by an inter-track distance 37.

In general, the width of pairs of polar parts 30.1 to 30.4 on the support 1000 will be denoted P, and the longitudinal pitch of the head gaps of pairs of polar parts on the support 1000 will be denoted T. Let L be the width of a track 36, and let i be the width of an inter-track distance 37 (measured perpendicular to the direction x).

The tilt angle θ is expressed as:

sin(θ)=(L+i)/(T)

The width of inscribed tracks is given by:

L=P·cos(α−θ)/cos(α)

We will now give a realistic numerical application. If T=200 μm, L=5 μm and i=0.1 μm (the smallest possible inter-track distance), we can deduce:

sin(θ)=(L+i)/(T)=5.1/200=0.0255, hence θ≈1.5°.

As shown in FIG. 2, it is possible that the azimuth angle α is equal to a value different from the value of the tilt angle θ, Recorded bits will be at an angle α-θ with the general direction x of the inscribed track. As a variant, as shown in FIGS. 3A, 3B, it is possible that the azimuth angle α and the tilt angle θ are equal: α=θ. In this case, the bits will be inscribed perpendicular to the general direction of the tracks. This variant corresponds to the existing recording standard.

We then obtain:

L=P·cos(α−θ)/cos(α)=P/cos(α), or

P=L·cos(α)

By using the values of the above numerical application, we obtain P≈5 μm if α=θ and α≈1.5°.

We will now describe a method for manufacturing such a recording and/or read device capable of obtaining such a small azimuth angle α.

When it is required to make a recording and/or read device, it is preferable to dissociate the magnetic heads dedicated to recording from the magnetic heads dedicated to reading, for performance reasons. Magnetic heads dedicated to reading are preferably chosen from among the magnetoresistance MR, giant magnetoresistance GMR and tunnel magnetoresistance TMR types, while magnetic write heads are preferably magnetic inductive heads.

Refer to FIGS. 3A, 3B, 3C.

The recording and/or read device may comprise one or several first blocks B1 of at least one support 45 comprising recording heads (materialised by their pairs of polar parts 40w and their head gap e) and one or several second blocks 332 of at least one support 46 comprising read heads (represented by their pairs of polar parts 40r and their head gap e), these first and second blocks B1, B2 being placed one after the other in the general direction x of the tracks 47 of the magnetic recording medium 44. The inter-track distances are referenced 41.

In FIG. 3A, there is only one first block B1 dedicated to writing (recording), and it is followed by a single second block B2 dedicated to reading. Each of the first and second blocks B1, B2 comprises the same number of write heads 40w as read heads 40r that are aligned with each other to cooperate with each other.

In FIG. 3B, the recording and/or read device comprises several (two in the example) first blocks B1, one after the other in the general direction of the tracks 47 and that are dedicated to writing, and several (two in the example) second blocks B2 one after the other in the general direction of the tracks 47 and that are dedicated to reading. All first blocks B1, and all second blocks B2 comprise the same number of write heads 40w (and read heads 40r) as the number of tracks 47 on the magnetic medium 44 that will be written in a single pass. This final configuration can increase the recording density by reducing the width of the tracks and the width of inter-tracks, without necessarily eliminating the inter-track distances.

FIG. 3C shows a similar recording and/or read device capable of writing and reading the <<double azimuth-controlled>> tracks 47, in other words the azimuth angle of bits inscribed on odd tracks starting from the top is α1-θ1 and the azimuth angle of bits inscribed on the even tracks is α2-θ2. This type of device can maximise the recording density by authorizing a non-zero inter-track distance with no crosstalk when reading.

In the recording block B1 that has two supports 45, one of the supports 45 has a tilt angle θ1 and the other has a tilt angle θ2 that may be different from θ1. The head gap of the pairs of polar parts 40w of one of the supports has an azimuth angle α1 and the head gap of the polar parts 40w of the other support has an azimuth angle α2. Similarly, in the read block B2 that also has two supports 46, one of she supports 46 has a tilt angle θ1 and the other has a tilt angle θ2 so that she heads of block B2 can read information written by the heads of block B1. The head gap of the pairs of polar parts 40r of one of the supports has an azimuth angle α1 and the head gap of the polar parts 40w of the other support has an azimuth angle α2. The two supports on each block are assembled, for example using shims 49 that make it easy to adjust the tilt angles of each of the supports.

In order to prevent crosstalk between blocks dedicated to different functions, a magnetic shielding screen 48 may be placed between the first blocks B1 and the second blocks B2.

Appropriate means known to a person skilled in the art may be provided to combine the recording and read functions. For example, all blocks B1, B2 could be fixed by mechanical assembly. After assembly of the blocks B1, B2 and the shielding screen 48 (if there is one), the result will be a recording and read device denoted RWW (Read While Write). One advantage of such a device is that it is capable of verifying the integrity of recorded data while writing. Writing is done before reading.

Refer to FIG. 4, Instead of the write blocks B1 and the read blocks B2 being one after the other in the axial direction of the tracks 47 on the magnetic recording medium 44, they are stacked one on top of the other. A write block B1 formed of several recording heads 40w placed on at least one support 1000 can be combined with a read block B2 formed of several read heads 40r placed on at least one support 1001. The read heads 40r and the record heads 40w are shown by their pairs of polar parts and their head gap e.

In FIG. 4, each block B1 or B2 comprises a single support 1000 or 1001. The supports 1000, 1001 are initially distinct and are assembled by forming the space 33 controlling the inter-polar part distance d. The space 33 may contain magnetic shielding and/or an electrical insulation. It may also contain magnetoresistive read means. This space 33 can be used to set parameters for the alignment between the magnetic write heads and magnetic read heads using its thickness d.

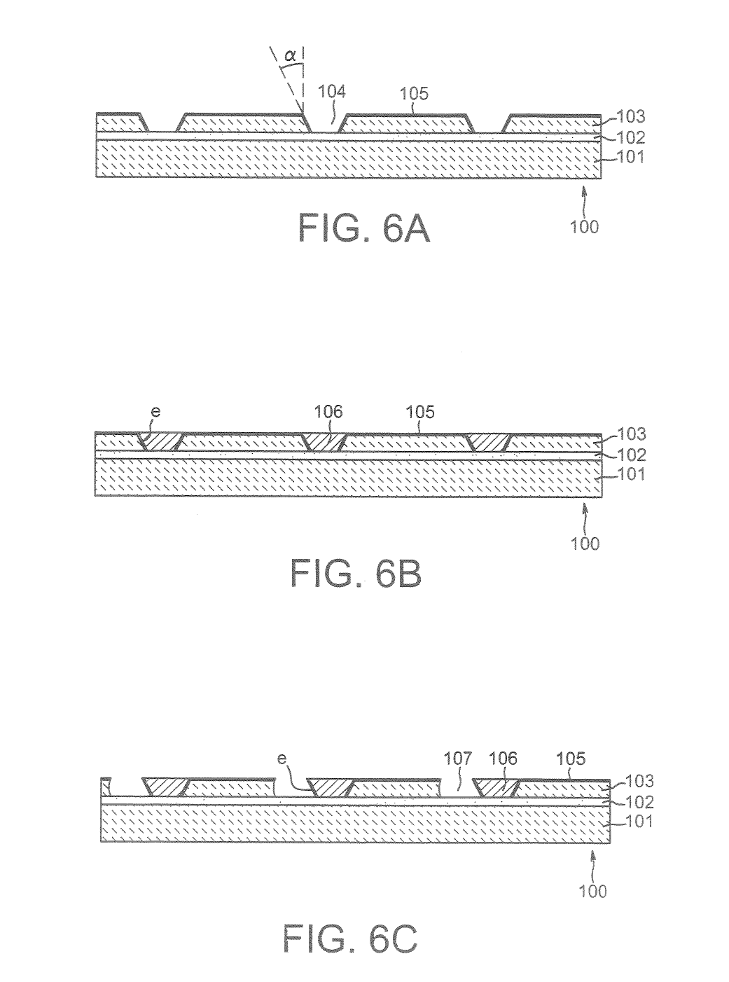

As a variant, the two supports could be combined into a single support, in which the magnetic write heads and the magnetic read heads are placed on each side of an insulating layer 25 of the support 63 as shown in FIG. 5B. In this case, the support is multi-layer, and it could for example be an SOI (semiconductor on insulator) type substrate, or more generally an XOI type substrate where X is a monocrystalline material. The polar parts are located on each side of the insulating layer. The external layers of the common support can be considered like two supports assembled one with the other.

In the embodiment shown in FIG. 4, all azimuth angles α of the writing or reading magnetic heads are equal. The two supports 1000 and 1001 have the same tilt angle θ.

One advantage of a recording and/or read device like that shown in FIG. 4 and in FIGS. 3A, 3B is that it facilitates positioning of the read heads 40r with respect to the write heads 40w. An inter-track distance with reference 41 is kept to take account of any misalignment problems, namely track following problems, or to insert tracks written by another head or another similar device with a different azimuth angle.

In FIG. 4, the recording and/or read device shown is an RWW (Read While Write) device. The magnetic write heads 40w and magnetic read heads 40r may have an advantageous alignment when the following parameters satisfy the formula:

P+d=(D−nT)tan(θ)

where θ is the tilt angle of the supports 1000, 1001 from the tracks 47, T is the longitudinal pitch of the head gaps of the pairs of polar parts located on a given support, D is the longitudinal offset from one supports between two pairs of consecutive polar parts placed on two consecutive supports, P is the width of polar parts and n is an integer number. Technical-economic optimisation of these magnetic heads will affect the choice of parameters for the formula.

In FIG. 4, the integer n is equal to 1. The distance d may be adjusted without any severe technological constraints. It is expedient to choose n≦2 to limit the size of the magnetic heads, and the distance between the read and write head gaps.

FIGS. 5A, 5B show a three-dimensional view of a conventional recording and/or read device, and FIG. 5B shows a similar view of a recording and/or read device according to the invention, associated with a magnetic recording medium 64 with approximately parallel linear tracks 61 separated by an inter-track distance 62. The width of the inter-track 62 is w0 in FIG. 5A and w1 in FIG. 5B. Recorded information, in the form of a sequence of bits orthogonal to the tracks, is represented on two of the tracks 61.

In both of these cases, the recording device comprises a sequence of magnetic recording and/or read heads 60, for which the pairs of polar parts are supported on the same approximately plane support 63.

The magnetic heads 60 are shown entirely on these figures. Each comprises a pair of polar parts 50, 51 separated by the amagnetic head gap 52, and also a magnetic flux guide 53 that magnetically couples the two polar parts 50, 51 in a pair and recording and/or read means 54 that cooperate with the magnetic circuit composed of polar parts 50, 51 and the magnetic flux guide 53.

The recording and/or read means may be inductive or magnetoresistive. In the examples in FIGS. 5A, 5B, the recording and/or read means 54 are Inductive, and for each magnetic head 60, are in the form of at least one solenoid that surrounds the magnetic flux guide 53.

In FIG. 5A, the magnetic circuit is in a plane perpendicular to the support 63, it is approximately in the shape of a horseshoe and terminates at each of its ends by one of the polar parts 50, 51 in a pair. The head gap 52 is directed parallel to the plane of the support 63. These magnetic heads 60 have an azimuth angle α=90°, the azimuth angle α being measured from a normal to the support. The magnetic recording medium 64 travels in front of the magnetic recording and/or read heads 60 along the direction identified by the arrow. The plane of the support 63 is approximately perpendicular to the general x direction of the tracks 61. The tilt angle θ is equal to 90°, the tilt angle θ being the angle between the support and the general direction of the tracks.

On the other hand, in FIG. 5B, the magnetic flux guide 53 comprises two legs 53.1, 53.2 magnetically connected firstly to a polar part 50, 51 and secondly to a single rear magnetic closing part 53.3. The recording and/or read means 54 are in the form of solenoids 54 that cooperate with the legs 53.1, 53.2 of the magnetic flux guide 53. A monolithic magnetic circuit structure may be used in a magnetic head of a recording and/or read device according to the invention.

In FIG. 5B, the support 63 is common for two series of magnetic heads. They are placed on each side of an insulating layer 33 of the support 63. Thus, this structure may be considered like a structure with two consecutive supports 63.1, 63.2 forming a common support 63 on which two series of pairs of polar parts are placed on each side of an electrically insulating layer 33 of the common support 63.

The magnetic heads are azimuth-controlled, their head gap 52 has an azimuth angle α measured from a direction normal to the plane of the magnetic circuit (plane of the support 63 in FIG. 5B). This azimuth-angle is between ±90° excluding limits. The plane of the magnetic circuit (plane of the support 63 in FIG. 5B) is tilted by a non-zero angle θ between ±90° from the general direction x of the tracks 61.

Compared with the structure in FIG. 5A, the structure in FIGS. 2 and 5B may easily lead to tracks with close spacings, in other words small inter-track widths (w1<w0) or even zero inter-track widths: all that is necessary is to choose a sufficiently small tilt angle θ. Furthermore, recorded bits are orthogonal to the general direction of the tracks when α is chosen to be equal to θ.

The inter-support layer 33 may be composed of an insulator, for example silicon oxide (SiO₂), silicon nitride (Si₃N₄), alumina (Al₂O₃), zirconium (ZrO₂), silicon carbide (SiC), AlSiC (mix of alumina and silicon carbide), titanium carbide (TiC), AiTiC (mix of alumina and titanium carbide) or any other insulator with good resistance to wear. This layer can be made in one or several steps, for example by a deposition method using microelectronics equipment or micro on nanotechnology equipment, for example such as cathodic sputtering (PVD, PECVD, etc.). If the insulating layer of an SOI/XOI substrate is used as the inter-support layer 33, its thickness shall be adjusted by the substrate manufacturer, by any method used in this type of industry. To make it easy to assemble the supports 1000 and 1001 in FIG. 4 on each side of the inter-support layer 33, the inter-support layer can be made on either one or both of the supports 1000, 1001, for example using mechanical-chemical levelling steps and appropriate surface preparations so that assembly can be made later with precise positioning. The inter-support distance d will then obviously be the sum of the thicknesses deposited on each support 1000 and 1001. Each of these thicknesses may possibly contain one or several magnetic shields and/or magnetoresistive elements (GMR or more generally XMR) buried in the insulator 33 (deposited and/or etched by appropriate micro-technological equipment).

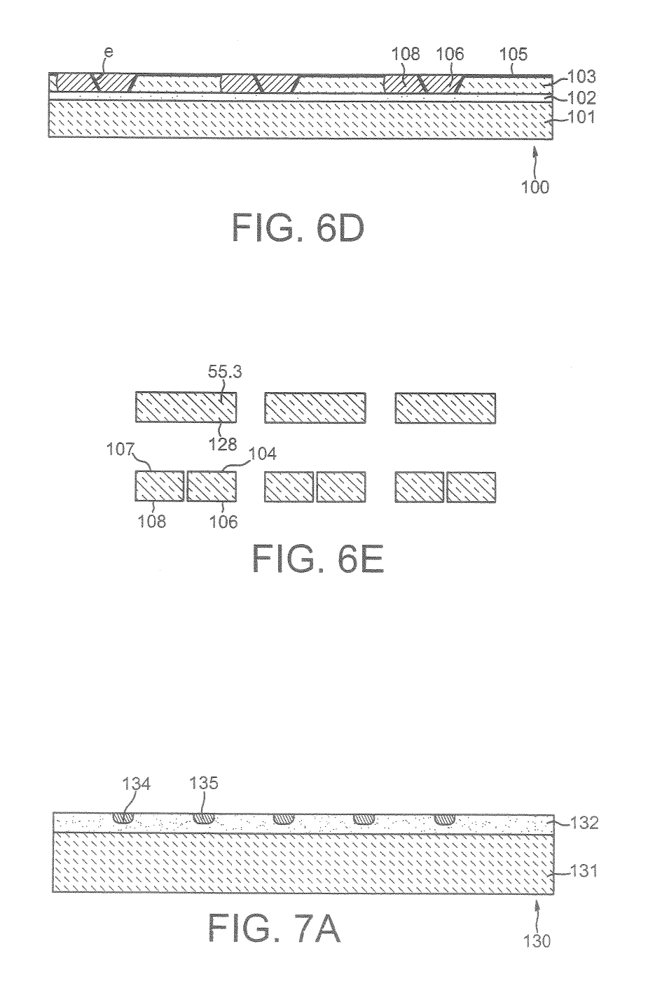

We will now describe an example embodiment of a recording and/or read device according to the invention similar to that shown in FIG. 5B, with reference to FIGS. 6A to 6E. This method is based essentially on the information disclosed in patent applications FR-A1-2 664 729 and FR-A1-2 745 111 in the name of the applicant. The magnetic heads are made collectively, and in this example, it is assumed that they are inductive heads, Magnetic heads are made on substrates and they correspond to the supports described above.

In the examples, the recording and/or read device comprises two substrates, each supporting three magnetic heads. In a real device, there will be many more magnetic heads, for example of the order of several hundred magnetic heads.

The starting point is a substrate 100 with an electrically insulating layer 102 sandwiched between two external layers 101, 103, at least one 103 of which is made from a monocrystalline material.

It could be a semiconductor on insulator type substrate, for example an SOI (Silicon On Insulator) type substrate. Remember that such a substrate is composed of an electrically insulating layer 102 sandwiched between two semiconducting layers 101, 103. In general, one of the semiconducting layers is thicker than the other. However, such a semiconductor on insulator substrate is not compulsory.

Advantageously, the other external layer 101 may be made from a wear resistant material, this material being neither semiconducting nor monocrystalline. For example, it could be made from zirconium ZrO₂, silicon carbide and alumina AlSiC, titanium carbide and alumina AlTiC, alumina Al₂O₃ or other. This external layer 101 is advantageously thicker than the monocrystalline layer.

The fact that at least one of the external layers is monocrystalline will be used to make etchings controlling the azimuth angle of the head gaps. Therefore, its crystallographic orientation will be chosen as a function of the required azimuth angle.

The first step will be to make pairs of polar parts 106, 108 of each magnetic head, the head gaps e and the rear magnetic closing parts 55.3 that are parts of the flux guide of the magnetic circuit of each of the magnetic heads of the recording and/or read device.

The first flared caissons 104 that will hold one of the polar parts in each pair of polar parts to be located on this first substrate will be etched in the external monocrystalline layer 103 (FIG. 6A). For example, in the case of silicon, this etching will consist of a wet anisotropic chemical etching, for example in a potassium bath KOH. The inclination of one of the sides of each first caisson controls the value of the azimuth angle α. This azimuth angle is the same for all head gaps no be made. This inclination takes advantage of the monocrystalline nature of the substrate, the anisotropic etching following a crystallographic plane of the substrate. In silicon, the planes in the <111> family limit the etching edges. These substrates are available off-the-shelf. For example, this method is described in document FR-A1-2 664 729.

The layer of electrically insulating material 102 of the substrate 100 is used as a stop layer while etching the first caissons 104. The thickness of the semiconducting surface layer 103 of the substrate 100 controls the width of the polar parts of pairs located on this first support.

The next step is to form a layer 105 of an amagnetic material with an approximately uniform thickness on the sides of the first caissons 104. If the first caissons are made from silicon, they can be done by a surface thermal oxidation of the first substrate thus worked in this way (FIG. 6A). As a variant, the amagnetic material could have been deposited on the sides of the first caissons.

The layer 105 of amagnetic material that coats one of the flared sides of each of the first caissons 104 will form the azimuth head gap e of each of the pairs of polar parts located on the substrate 100.

A magnetic material is deposited in the first caissons 104, for example by electrolysis. The magnetic material may or may not be laminated, for example it may be an alloy of NiFe, CoFe or CoFeX, where X represents an appropriate material such as Cr, Cu or other.

The surface of the substrate 100 thus worked is levelled such that the oxide is flush with the surface and the magnetic material has the required thickness (FIG. 6B). This magnetic material forms a first polar part 106 of each pair of polar parts.

The next step is to isotropically etch second caissons 107 that will hold the other polar part in each pair of polar parts that will be located on the first substrate 100 (FIG. 6C). These second caissons 107 are contiguous with the first caissons 104 and are all located on the same side of these first caissons 104. In the example, they are to the left of the first caissons 104. They could be to the right. The azimuth angle would then be different, it would be in another plane of the <111> family. The monocrystalline material in the surface layer 103 that is close to the head gap e is removed by etching. The amagnetic material in the head gap e is used as a side for these second caissons 107.

The third caissons 128 that will hold the rear magnetic closing parts of the magnetic circuit that will be terminated later, could also be etched during this step. These third caissons 128 are located facing each of the pairs of polar parts 106, 108. Refer to FIG. 6E that shows a top view of the pairs of polar parts 106, 108 and the rear magnetic closing parts 55.3.

The depth of these second caissons and these third caissons is approximately the same as the depth of the first caissons due to the stop layer 102 that limits the two etchings.

These second caissons 107 and third caissons 128 are filled with a magnetic material and the work is terminated by a levelling step as described above (FIG. 6D). The magnetic material forms the second polar part 108 of each pair and the rear magnetic closing part 55.3. This levelling step finally adjusts the width P of the pairs of polar parts. It also equalises the area of the polar parts of each pair, giving them a very good alignment on their upper face (in FIG. 6D), their lower face supported on the insulating layer 102 already being plane and having very good alignment.

We will now make the rest of the magnetic circuit flux guide for each of the magnetic heads in the device, in other words in this example, the magnetic legs that magnetically connect the two polar parts of one pair to the rear magnetic closing part and the recording and/or read means. The method used is based on the information given in patent application FR-A1-2 745 111.

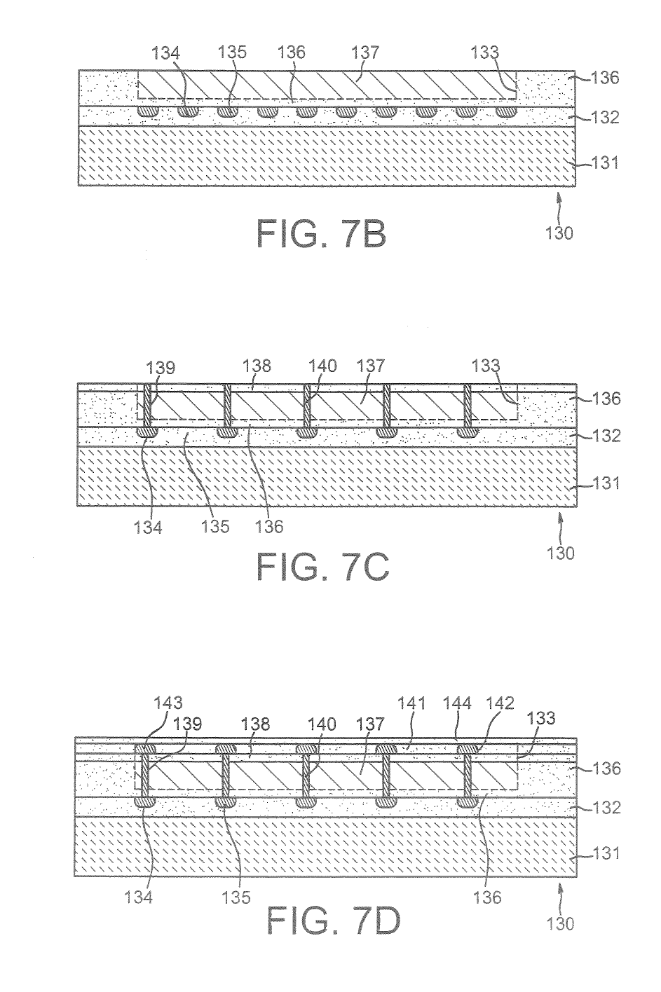

Note that in this example, the recording and/or read means are solenoids that surround the magnetic circuit at the legs or branches of the horseshoe, Refer to FIGS. 7A to 7E. FIGS. 7A to 7D are sections along a leg of the magnetic circuit.

There is a second substrate 130, called an additional substrate, with a base layer 131, for example a semiconducting layer covered by a layer made from an electrically insulating material 132. A bulk substrate could very well be used for the base layer 131, possibly wear resistant.

The first step will be to form a first layer of conductors for each solenoid, that will extend between a polar part and a rear magnetic closing part, or along a branch of the horseshoe-shaped magnetic circuit.

This is done by forming first parallel grooves 134 approximately perpendicular to the axis of the magnetic cores of the solenoids, in the insulating layer 132 at the locations at which the solenoids are to be located. These cores correspond to the legs 53.1, 53.2 shown in FIG. 5B.

These first grooves 134 are filled in by depositing a conducting material 135, based on copper, for example by electrolysis (FIG. 7A). This conducting material 135 forms conducting portions in the first layer of conductors.

The next step is levelling, for example mechanical or preferably mechanical-chemical to eliminate the superfluous conducting material 135 above the grooves 134.

An electrically insulating layer 136 for example made from silicon oxide is deposited, for example by PECVD, over the entire levelled surface, thickness greater than the required thickness for the legs. The insulating layer 136 is etched so that caissons 133 appear at the legs of the magnetic circuit to be made. The thickness of the bottom of these caissons 133 is sufficient to electrically insulate conductors in the first layer of conductors from the magnetic circuit. A magnetic material 137, possibly laminated as described above, is deposited in these caissons 133 to make polar parts (FIG. 7B). The surface obtained is levelled as described above.

We will now make the lateral conductors of the solenoids. An electrically insulating layer 138 is deposited on the levelled surface (for example silicon oxide by PECVD). The sinks 139 are etched in the insulating layers 138 and 136 until the ends of the conductors 135 in the first layer of conductors are reached. These sinks 139 are filled with conducting material 140, for example a copper-based material, for example by electrolysis (FIG. 7C). The surface obtained is levelled. This conducting material forms the lateral conductors 140 of the solenoids.

The next step shown in FIG. 7D is to make a second horizontal layer (on the figure) of solenoid conductors by depositing a layer of electrically insulating material 141 on the surface of the structure obtained, by etching second grooves 142 in this material, the ends of which expose the lateral conductors 140 thus made. The second grooves 142 are filled with conducting copper-based material 143, for example deposited by electrolysis. The surface obtained is levelled. The conducting material 143 forms conductors in the second layer of solenoid conductors. The conducting material 143 is covered by a layer of electrically insulating material 144. it is planned to make the contact at the ends of the solenoid conductor (not visible).

The caissons 133 in FIGS. 7C and 7D are shown in dashed lines, to show that they are not in the same section plane as the sinks 139. These sinks are actually [symbol] in front of [symbol] the caissons 133, they do not pass through the magnetic material 137 that fills in the caissons but they do pass through the material in the insulating layer 136. The grooves 134 are not quite perpendicular to the axis of the caissons 133.

FIG. 7E illustrates the configuration of the second substrate 130 just before being assembled to the first substrate 100, at a scale different from the scale of FIGS. 7A to 7D, and in a side view of FIG. 7D.

The second substrate 130 may possibly hold signal processing means processing signals output or acquired by the magnetic heads.

The second substrate 130 in FIG. 7E and the first substrate shown in FIG. 6D are positioned with alignment, and are assembled after turning one of them over. Special attention is paid to making magnetic contact firstly between the legs of the magnetic circuit and the pairs of polar parts, and secondly between the legs of the magnetic circuit and a rear magnetic closing part.

The assembly may be made by any technique known to a person skilled in the art of micro-technologies and particularly micro-electromechanical systems (MEMS).

Advantageous assembly methods include bonding by glue, anodic bonding, direct bonding as described in document FR-A-2 774 797 or flip chip bonding.

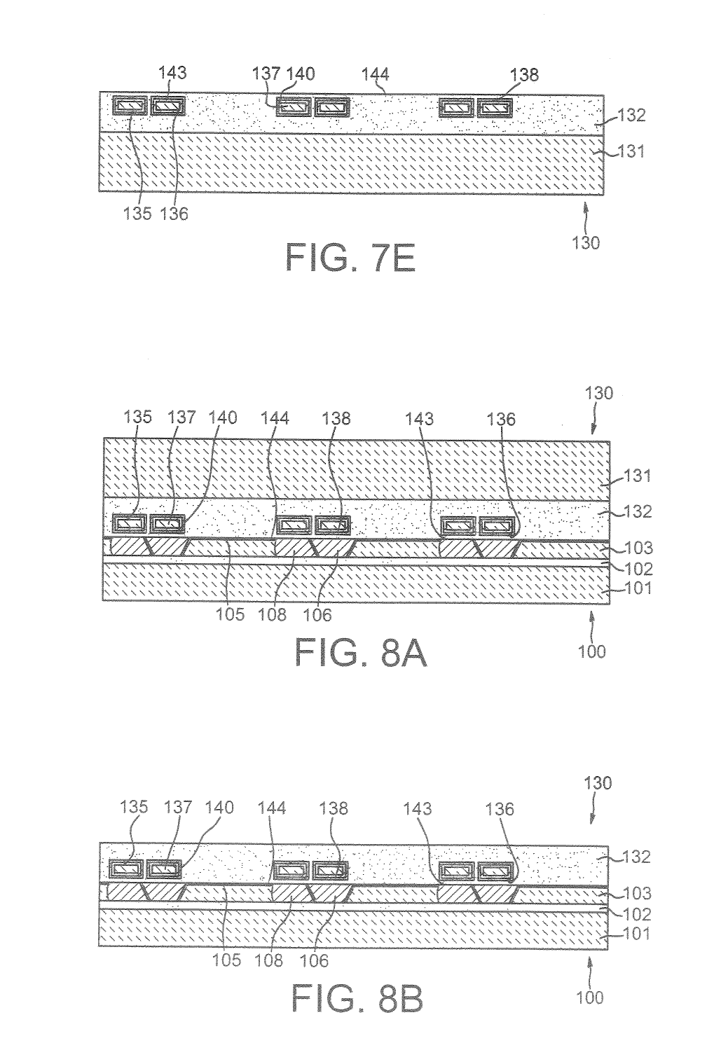

In FIG. 8A, the second substrate 130 was assembled by direct or other bonding, with alignment such that each magnetic circuit 137 is magnetically connected to a pair of polar parts 106, 108, this connection being made directly. For example, the alignment may be made by Infrared sighting, or sub-X rays.

The only remaining step is possibly to totally or partially eliminate the base layer 131 of the second substrate 130 (FIG. 8B), for example by complete or local selective etching of the material in this base layer 131 stopping on the insulating layer 132. Thus, contact can be made through the insulating material of the layer 132 to provide power supply for the recording and/or read means (the solenoids formed by 135, 140, 143 in this particular case).

It may be useful to keep the unworked layer 101 of the first substrate 100, in this case it can advantageously be made from a wear resistant material, for example made from AlTiC, ZrO₂, AlSiC.

Instead of making the remainder of the flux guide for each of the magnetic heads and the recording and/or read means on the additional substrate, it would have been possible to make them on the first substrate 100 at the stage shown in FIG. 6D following the steps described in FIGS. 7A to 7E. A structure obtained in this way would be similar to the structure shown in FIG. 8B. It is then superfluous to show the different steps leading to such a structure, all that is necessary is to refer to the description in FIGS. 7A to 7E, with the only difference that the electrically insulating layer 132 will be deposited on the first substrate 100 in the stage shown in FIG. 6D. For example, silicon oxide could be deposited by PECVD.

The next step is treatment of the structure obtained in FIG. 8B so as to make the substrates have a given tilt angle θ from the magnetic tracks of the magnetic recording medium.

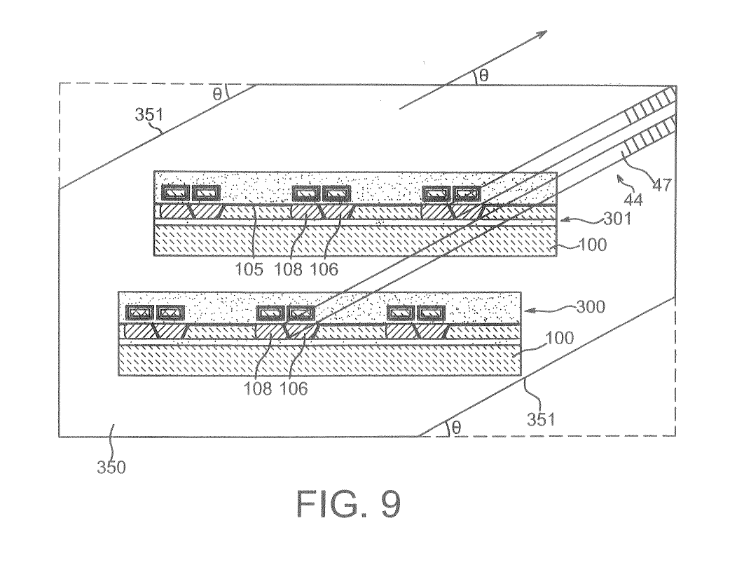

This treatment may consist of integrating one or several blocks (or chips) of magnetic heads on a common mechanical support. Refer to FIG. 9. Firstly, the magnetic heads are tested and the structure in FIG. 8B is cut into blocks (or chips) 300, 301. As described above, several hundred magnetic heads are made collectively. One or several of these blocks 300, 301 is mounted on a given mechanical support 350. This step is known under the term [symbol] back-end [symbol] or [symbol] packaging [symbol] . The mechanical support 350 will advantageously be made from a wear resistant material for example AlTiC (titanium carbide and alumina) that is currently used by manufacturers of linear magnetic heads.

The next step is to grind the contour of the mechanical support 350, for example at its faces 351 such that the first substrate 100 can have a required tilt angle θ with respect to the tracks 47 of the magnetic recording medium 44.

Obviously, the mechanical support is not necessary. The structure shown in FIG. 8A could be ground directly before or after cutting into chips so as to create the tilt angle θ, particularly if it is small, on the external faces of substrates 100 and 110. In this case, the electrical contacts will advantageously be made by local etching.

A second embodiment of a recording and/or read device according to the invention will be described, this device being shown in FIG. 10. This is a device called a read while write device. This device is particularly attractive because it is capable of verifying the integrity of recorded data during the recording.

The device according to the invention comprises first magnetic heads 90 dedicated to writing and second magnetic heads 91 dedicated to reading. These first and second magnetic heads form an alternating sequence, in other words a first magnetic head 90 in the sequence is adjacent to a second magnetic head 91.

The first pairs of polar parts pp11, pp12 of the first magnetic heads 90 are distributed on a substrate 93, and the second pairs of polar parts pp21, pp22 of the second magnetic heads 91 are distributed on another substrate 94, and the two substrates are stacked. The first and second magnetic heads 90, 91 are azimuth-controlled and they are both at the same azimuth angle α defined as described above.

The recording means of the first magnetic recording heads 90 are in the form of solenoids s1.1, s1.2, while the read means in the second magnetic read heads 91 are of the magnetoresistance type and are in the form of at least one rod g, for example made from a GMR material.

The flux guide c1, c2 of the magnetic circuit of each of the first and second magnetic heads 90, 91 magnetically connects the polar parts pp11, pp12, pp21, pp22 of a head 90, 91 respectively. This flux guide c1, c2 may comprise two legs j1.1, j1.2, j2.1, j2.2 magnetically connected firstly to a polar part pp11, pp12, pp21, pp22 and secondly to a rear magnetic closing part a1, a2. The connection between the legs j1.1, j1.2, j2.1, j2.2 and the polar parts pp11, pp12, pp21, pp22 may be direct or it may be made through magnetic connection pads p1.1, p1.2, depending on the substrate on which the polar parts of the magnetic head are located.

As a variant, the flux guide of the magnetic circuit may be monolithic, shape approximately like a horseshoe or a similar shape, in which each of the ends is magnetically connected to a polar part.

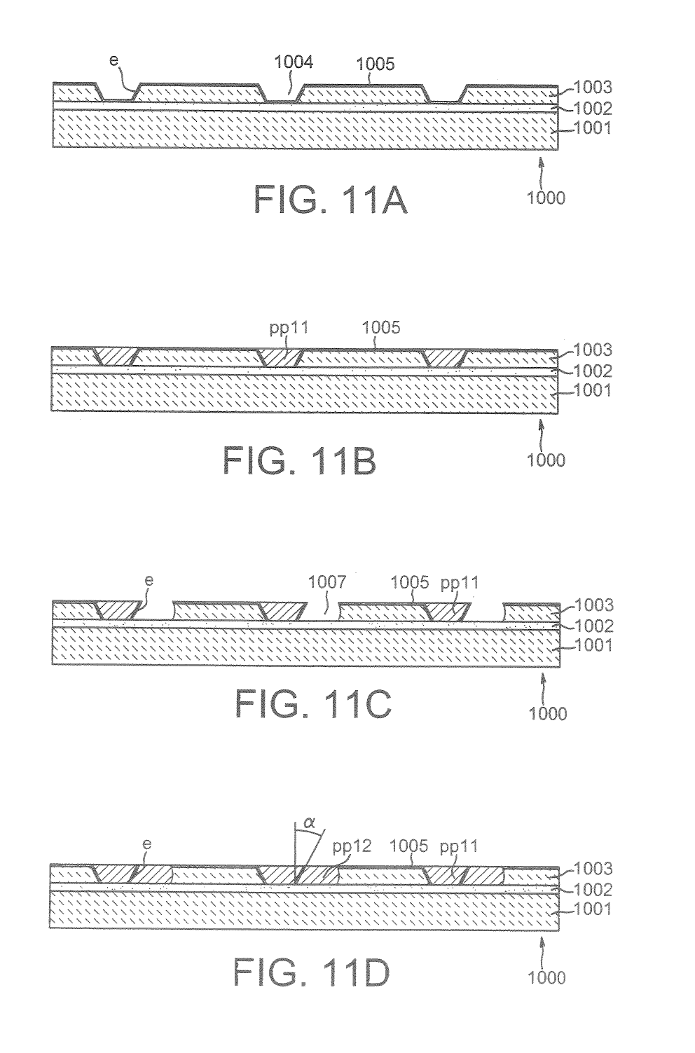

Refer to FIGS. 11A to 11D.

Start from a first substrate 1000 with an electrically insulating layer 1002 sandwiched between two external layers 1001, 1003, at least one 1003 of which is made from a monocrystalline material.

It could be a semiconductor on insulator type substrate, for example an SOI type substrate. However, such a semiconductor on insulator substrate is not essential.

Advantageously, the other external layer 1001 could be made from a wear resistant material, this material being neither semiconducting nor monocrystalline. For example, it could be made from zirconium ZrO₂, AlSiC (silicon carbide and alumina), AlTiC (titanium carbide and alumina), alumina Al₂O₃, or other. This external layer 1001 is advantageously thicker than the monocrystalline layer.

The first pairs of polar parts pp11, pp12 of the first magnetic heads 90 are then made. The first flared caissons 1004 that will hold one of the polar parts in each first pair of polar parts to be located on this first substrate 1000 are then etched in the monocrystalline layer 1003 (FIG. 11A). As in the example described in FIG. 6, the thickness and crystallographic orientation of the monocrystalline layer 1003 are chosen such that the first polar parts have the required thickness and the required azimuth angle. This etching is an anisotropic etching similar to that described with reference to FIG. 6A, and this is why it is not described further.

The next step is to form a layer 1005 of amagnetic material, for example by surface thermal oxidation of the first substrate 1000 thus worked (FIG. 11A) when its layer 1003 is made from silicon. The substrate 1000 may consist of only the silicon layer 1003. The layer 1005 of amagnetic material coating one of the flared sides of each of the first caissons will form the azimuth-controlled head gap e of each of the first pairs of polar parts located on this substrate 1000.

A magnetic material (laminated or not laminated) is deposited in the first caissons 1004, for example by electrolysis. For example, the magnetic material could be an alloy of NiFe, CoFe or CoFeX, where X is an appropriate material such as Cr, Cu or other.

The surface of the substrate 1000 thus worked may be levelled such that the oxide is on the surface and the magnetic material has the required thickness (FIG. 11B). This magnetic material forms a first polar part pp11 in each pair of polar parts.

The next step is to isotropically etch the second caissons 1007 that will hold the other polar part pp12 of each pair of polar parts that will be located on the first substrate 1000 (FIG. 11C). These second caissons 1007 are contiguous with the first caissons 1004 and are all located on the same side as these first caissons 1004. In the example, they are to the right of the first caissons 1004. They could be to the left.

The monocrystalline material of the external layer 1003 adjacent to the head gap e is removed by etching. The amagnetic material in the head gap e is used as a side to these second caissons 1007. The depth of these second caissons is approximately the same as the depth of the first caissons due to the insulating layer 1002 used as a stop layer.

These second caissons 1007 are filled with a magnetic material (laminated or not laminated) by electrolysis and the final step is a levelling step as described above (FIG. 11D). This magnetic material forms a second polar part pp12 in each first pair of polar parts. This levelling step makes the final adjustment of the width of polar parts and aligns their edges.

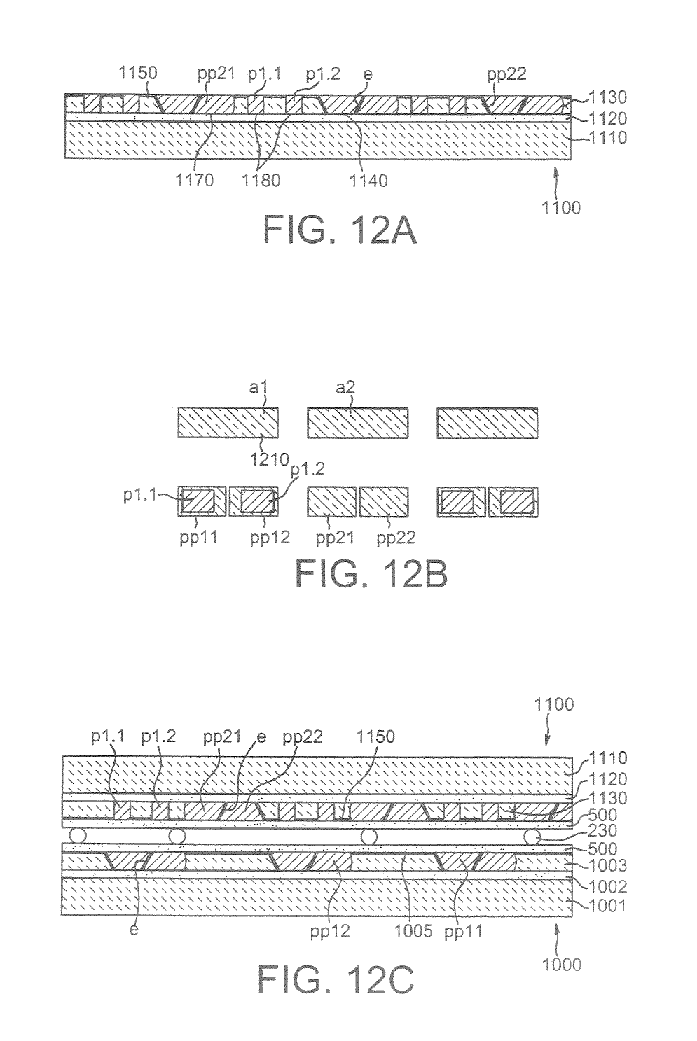

The next step is to make the second pairs of polar parts pp21, pp22 of the second magnetic heads 91. Refer to FIG. 12A. The starting point is a second substrate 1100 comprising an insulating layer 1120 buried between two external layers 1110, 1130, at least one 1130 of which is monocrystalline (for example an SOI substrate). Explanations on the choice of the first substrate and the thickness of its monocrystalline layer are applicable for the second substrate.

First caissons 1140 are made in the monocrystalline layer 1130 by anisotropic etching, and are filled with magnetic material (laminated or not laminated), by including a step in which an amagnetic material layer is formed (for example by surface thermal oxidation in the case of silicon), before filling and levelling as described with reference to FIGS. 11A and 11B. The layer of amagnetic material is marked with reference 1150 and one of the second polar parts is marked with reference pp22. The portion of amagnetic material 1150 on one of the sides of the first caissons 1140 will form the head gap e of the second pairs of polar parts.

Second caissons 1170 are made by isotropic etching as described with reference to FIG. 11C. The second caissons 1170 are adjacent to the first caissons 1140 and are both located on the same side of these first caissons 1140. In the example, they are to the right of the first caissons 1140 as explained above when producing the first pairs of polar parts on the first substrate 1000. They could be to the left, depending particularly on the relative movement required when one of the substrates is turned over with respect to the other at the time of their assembly. The position of the second caissons 1170 also depends on the final azimuth angle of the pairs of polar parts located on the second substrate. Thus, its sign can change during the subsequent step to assemble the first substrate to the second substrate.

Pairs of third caissons 1180 can be made at the same time between the groups of first and second caissons 1140, 1170 and they will hold pairs of magnetic connection pads p1.1, p1.2, each of which will magnetically connect polar parts pp11, pp12 of the first pairs of polar parts located on the first substrate 1000 to the magnetic circuit to be finalised later. These third caissons 1180 are positioned such that the magnetic pads of one pair are magnetically connected to the polar parts pp11, pp12 of a first pair of polar parts when the first substrate 1000 and the second substrate 1100 are assembled to each other after turning one of them over. A 180° flip about an axis transverse to the substrate could be introduced such that the required azimuth angles on the two substrates are obtained.

Fourth rear caissons 1210 that will hold the rear magnetic closing parts a1, a2 that are parts of the magnetic circuit of each of the first and second magnetic heads of the recording and/or read, device can be made at this stage, still by Isotropic etching. These rear parts are visible in FIG. 12B that shows a top view. These fourth caissons 1210 are positioned such that the rear magnetic closing parts a1, a2 are facing the first and second pairs of polar parts pp11, pp12, pp21, pp22. They are at the same level as the second pairs of polar parts pp21, pp22 but not at the same level as the first pairs of polar parts pp11, pp12. Refer to FIG. 12R that shows a partial top view of the pairs of magnetic pads p1.1, p1.2 and the rear magnetic closing parts a1, a2. Producing these fourth caissons 1210 is particularly important when the magnetic circuit comprises two magnetic legs and a rear magnetic closing part. This step is superfluous when the magnetic circuit is monolithic.

These second caissons 1170, third caissons 1180 and fourth caissons 1210 are filled with a magnetic material (laminated or not laminated) as described in FIG. 11D, and the surface is levelled. Finally, the magnetic material will form firstly the second polar parts pp21 of the second pairs of polar parts, and secondly the connection pads p1.1, p1.2.

The azimuth angle of head gaps e of the first and second pairs of polar parts was adjusted as required. These azimuth angles will be equal at the time of their manufacture since finally, after assembly of the substrates 1000 and 1100, the azimuth angles must all be equal and they must all have the same sign. The width of the polar parts that is not necessarily equal on the two substrates, was also adjusted as required. The magnetic read heads often read only part of the written track.

Before assembling the two substrates, it is advantageous to deposit an insulating layer 500 on the surface of at least one of the substrates 1000, 1100 (for example silicon oxide) and/or a layer of magnetic shielding, and to prepare the surface so as to adjust the inter polar part distance d. This layer 500 can thus be used to optimise assembly of the substrates. The material from which the insulating layer is made can advantageously be a wear resistant material so as to limit wear of the recording and/or read device. Selecting it can also facilitate assembly of the substrates.

Advantageously, openings can be left in the shielding layer 500 at the magnetic pads p1.1, p1.2, so that the shielding layer is located on one and/or the other of the substrates.

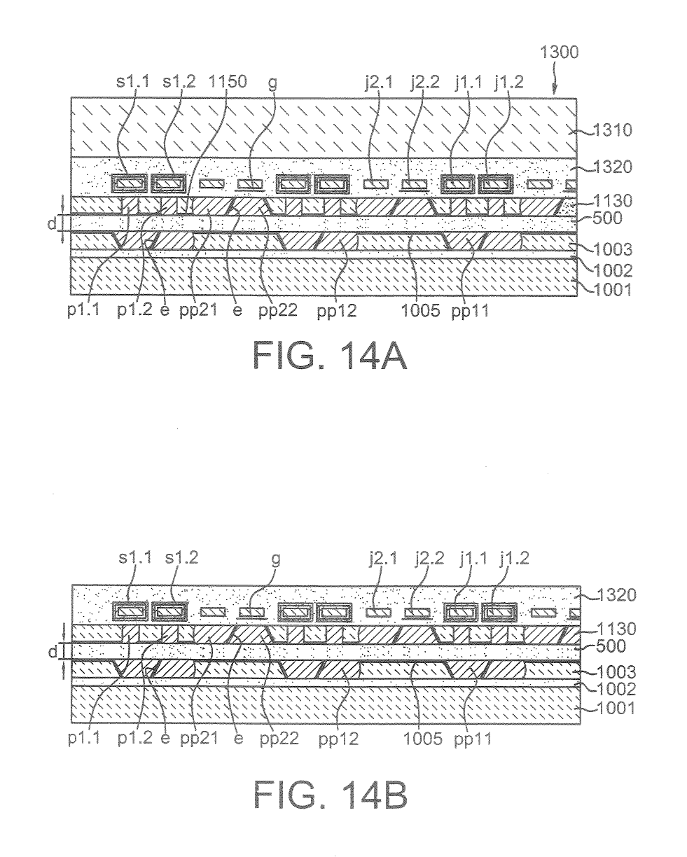

The insulating layer 500 on the side of the read heads may also contain magnetoresistive read means, which is particularly useful for magnetoresistive rods (MR, GMR) directly coupled to the polar parts. They are shown in FIG. 14C.

The next step will be to position and align the first substrate 1000 and the second substrate 1100, and to assemble them by their worked faces, after turning one of them over. Care is taken to align each magnetic pad p1.1, p1.2 with a polar part pp11, pp12 of the first substrate. This alignment may be done for example by infrared sighting, or under X-rays. Turning one of the substrates 1000 or 1100 over can change the sign of the azimuth angle of the pairs of polar parts located on this substrate. This depends on the method of working. If the substrate is turned over and rotated by 180° about a transverse axis at the same time, the sign will be changed.

Assembly may be made by any technique used in micro-technologies known to those skilled in the art or by direct bonding assembly as described in the previous example embodiment. Another particularly attractive assembly method is assembly by flip chip bonding. FIG. 12C diagrammatically illustrates the two substrates 1000, 1100 as shown in FIGS. 10D and 11A respectively, just before being assembled by bumps 230 made from a fusible alloy.

This solution can give a very precise (submicronic) alignment in X-Y, and can make electrical connections between the different substrates. Patent application FR-A-2 807 546 describes this assembly method, used particularly for print heads and this is why no further details are given herein.

The unworked layer 1110 of the second, substrate 1001 can then be eliminated. This elimination can be done selectively, for example by chemical etching for example using potassium hydroxide KOH, or by mechanical-chemical attack stopping on the buried insulating layer 112 (FIG. 12D). If necessary, the buried insulating layer 1120 can be thinned to make the second pairs of polar parts pp21, pp22 and the pairs of magnetic pads p1.1, p1.2 appear or almost appear.

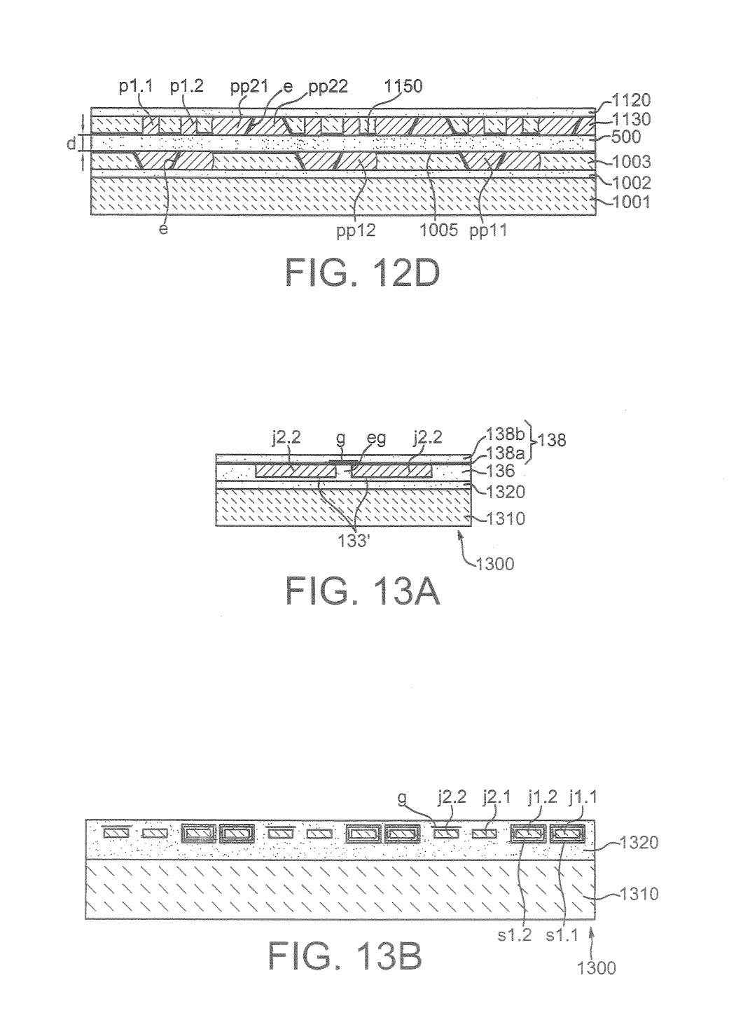

Refer to FIGS. 13A and 13B. The remainder of the flux guide of each of the magnetic heads will now be made, in other words in this example the magnetic legs j1.1, j1.2, j2.1, j2.2, and the recording and/or read means that are in the form of solenoids s11, s12 for the first magnetic heads 90, and in the form of a rod g for example made from GMR material for the second magnetic heads. If the rear closing magnetic parts in FIG. 12A are not made, the monolithic magnetic circuit will be shaped approximately like a horseshoe. The method used is based on the method described in patent application FR-A1-2 745 111.

Production of the legs and the solenoids is similar to what has been described with reference to FIGS. 7A to 7E, and this is why it is not described in detail again. There is a third so-called additional substrate 1300 with a base layer 1310 (for example semiconducting or wear resistant) covered by a layer of electrically insulating material 1320. It would have been quite possible to use a electrically insulating bulk substrate, or the bulk substrate could be covered by an insulator. The procedure is the same as that described in FIGS. 7 to 7C. However, caissons in which the conductors 134, 139 will be located are not etched at the locations of the legs 137 that will cooperate with the rods g of GMR material.

On the other hand, a head gap eg is made on each of the legs j2.2 concerned, by any means known in the state of the art, for example by making two adjacent sub-caissons 133′ instead of a single caisson in the insulating layer 136. These sub-caissons are shown in FIG. 13A. The sub-caissons 133′ are filled with magnetic material (laminated or not laminated) and are levelled. The insulating layer 138 in FIG. 70 will be deposited in several steps. A thin insulating sub-layer 138a (typically a few nanometers thick) will be deposited on the levelled surface, for example by sputtering. The next step will be to deposit a layer of GMR material. This layer is etched at the locations at which the GMR material is to be eliminated. The remaining GMR material is referenced g. It may be done by dry etching, for example. The next step is to deposit another sub-layer of insulator 138b to complete the layer 138. Solenoid windings can be continued as described in FIGS. 70, 7D. There is no need to describe these steps. A similar method could be used, to make rods g of GMR material under the legs j2.2.

The third substrate 1300 is shown in FIG. 13B in the same way as in FIG. 7E, with a base layer 1310 (for example a semiconducting layer) covered by a layer of electrically Insulating material 1320 supporting the magnetic legs j1.1, j1.2, j2.1, j2.2, the solenoids s11, s12 and the rods g made from a GMR material.

In FIG. 14A, the third substrate 1300 and the structure shown in FIG. 12D are aligned and positioned and assembled, after turning one of them over. The assembly can be made by one of the methods described above. The insulating layer 1120 can be partially or fully eliminated. The natures of the layers 1120 and 1320 are the same, therefore it is not necessarily required to eliminate the layer 1120 because it may be useful for direct bonding. Mechanical-chemical polishing can eliminate part of the layer.

In FIG. 14A, the third substrate 1300 was aligned and assembled by direct bonding or other means. Thus, each of the magnetic circuits j1.1, j1.2 is magnetically connected to a pair of polar parts pp11, pp12 through a magnetic pad p1.1, p1.2 and both are connected to a magnetic closing part a1. Similarly, each magnetic circuit j2.1, j2.2 is magnetically connected to a pair of polar parts pp21, pp22 and both are connected to a magnetic closing part. The last step is then to partially or fully eliminate the base layer 1310 from the third substrate 1300 (FIG. 14B), for example by selective etching of the semiconducting material, stopping on the insulating layer 1320. Thus, contact can be made through the insulating material of the layers 1320 and subsequent layers to supply power to recording and/or read means (solenoids s1.1, s1.2 and the rods g made from GMR material. FIG. 13A and FIGS. 13B and 14A, 14B are sections taken in different planes, this is why the head gap eg is only visible in FIG. 13A.

The next step is the assembly of one or several chips of multiple magnetic heads on a given mechanical support as described in FIG. 9. Grinding is then done, as explained in the description of this FIG. 9.

FIG. 14C illustrates another example of a recording and read device according to the invention, derived from the example on the FIGS. 14A, 14B. In this example, the first pairs of polar parts pp11, pp12 are dedicated to reading and the second pairs of polar parts pp21, pp22 are dedicated to recording. The layer 500 inserted between the first substrate 1000 and the second substrate 1100 contains a magnetic shielding screen 600. Magnetoresistive read means g cooperate with the first pairs of polar parts pp11, pp12. They are in the form of rods, for example made from MR or GMR material, and are located in the layer 500 on the same side as the first substrate 100 with regard to the shielding screen 600.

Magnetic circuits j2.1, j2.2 similar to those described in FIG. 7 are magnetically connected to the second pairs of polar parts pp21, pp22. They are located in the insulating layer 1320 of the third substrate 1300. Recording means s2.1, s2.2 of the inductive type similar to those described in FIG. 7 cooperate with the second, pairs of polar parts pp21, pp22. They are also located in the insulating layer 1320 of the third, substrate 1300.

Unlike the example in FIGS. 14A and 14B, the magnetic connection pads p1.1, p1.2 are missing.

Signal processing means 302, for example preamplifier circuits, multiplexers, demultiplexers, cooperate with the read means g and/or recording means s2.1, s2.2. They are made in a substrate 400 that is above the third substrate 1300 or in a layer of the third substrate 1300 if it is a multi-layer. They could be mounted on the surface of the third substrate 1300. They are positioned and aligned with the read means and the record means. They are electrically connected to the read and recording means through connection vias 303 that pass through the third and second substrates 1300 and 1100. Obviously, such signal processing means would cooperate with read means in the case of a read only device, or with recording means in the case of a record only device.

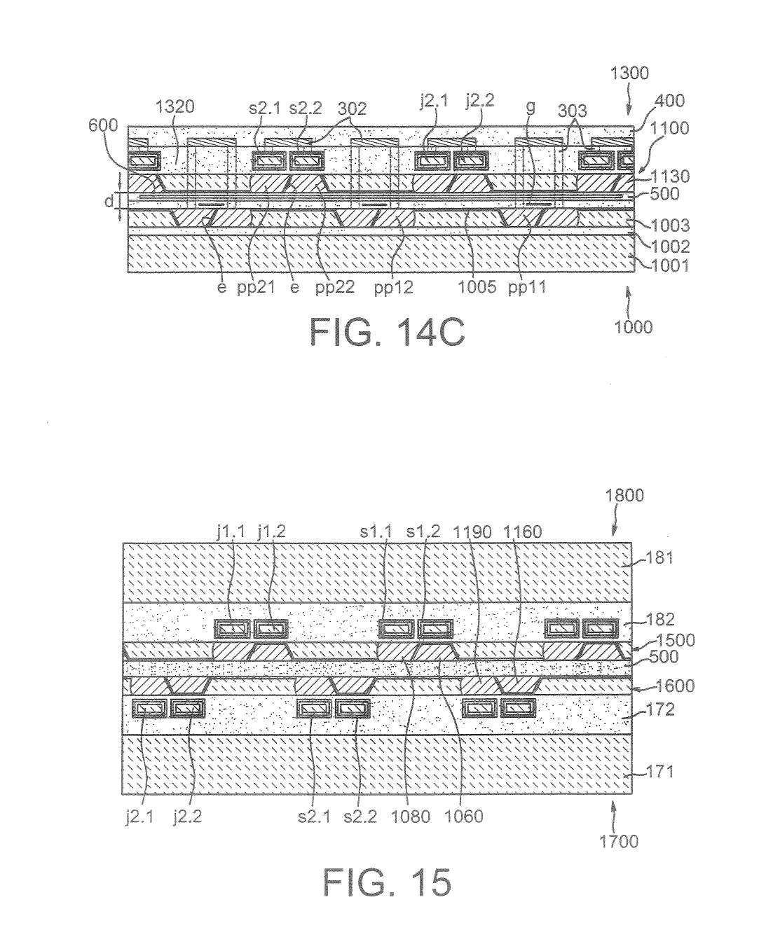

As a variant, in the case in which pairs of polar parts are distributed on several substrates, the record and/or read means can also be made on several substrates. Refer to FIG. 15. The first pairs of polar parts 1060, 1080 are made on a first substrate 1500, for example as described in FIGS. 6A to 6D. First flux guides j1.1, j1.2 of the magnetic circuits are at least partially made on a second so-called additional substrate 1800, with first recording and/or read means s1.1, s1.2 as described for example in FIG. 7 or FIG. 13A.

The first substrate 1500 and the second substrate 1800 are positioned and aligned and assembled after turning one of them over, such that each of the first magnetic flux guides j1.1, j1.2 is magnetically connected to one of the first pairs of polar parts 1060, 1080.

Second pairs of polar parts 1160, 1190 are made in the same way on a third substrate 1600, and second magnetic flux guides j2.1, j2.2 and second recording and/or read means s2.1, s2.2 are made on a fourth so-called additional substrate 1700. The third substrate 1600 and the fourth substrate 1700 are positioned and aligned and assembled after turning one of them over such that each of the first magnetic flux guides j2.1, j2.2 is magnetically connected to one of the first pairs of polar parts 1160, 1190.

The unworked layer 1510, 1610 and the layer of dielectric material 1520, 1620 are at least partially eliminated from the first substrate 1500 and from the third substrate 1600.

At least one layer of insulating material 500 is deposited on the faces supporting the pairs of polar parts of the two previously obtained structures. This layer may contain a shielding screen.

The two structures are positioned and aligned and assembled by their faces that have just been worked after one of them is turned over, taking care to stagger the first pairs of polar parts and the second pairs of polar parts. The assembly and alignment may be done as described above with reference to FIG. 10C. One of the unworked layers 1700, 1800 could be eliminated if required, and/or the second layer could be partially eliminated for example by chemical etching.

Electrical contacts (not shown) of the recording and/or read means can be made using an intra-connection technology, or for example by local etching (dry or wet).

Obviously, it would be possible to manage without the second substrate and/or the fourth substrate (in other words the additional substrates) as explained above, by making the flux guides and recording and/or read means directly on the first substrate 1500 and on the third substrate 1600 respectively, after thinning if required.

Although several embodiments of this invention have been represented and described in detail, it should be understood that different changes and modifications could be made to it without going outside the scope of the invention.

The different variant embodiments described should be understood as not being exclusive of each other.

1-39. (canceled)

40. A recording and/or read device of a magnetic medium with magnetic tracks, comprising:
plural magnetic heads each including a pair of polar parts separated by an amagnetic head gap,
wherein these pairs of polar parts are grouped on stacked supports, with a non-zero tilt angle between ±90° from the tracks, all head gaps of the pairs of polar parts in the support having the same azimuth angle, between ±90° excluding limits from a direction normal to the support, at least two consecutive supports of the stack defining a non-zero inter-polar part distance, which is the distance between planes of faces facing polar parts located on the two consecutive supports.

41. A recording and/or read device according to claim 40, further comprising a layer configured to define the inter-polar part distance inserted in the stack between the supports.

42. A recording and/or read device according to claim 40, wherein the inter-polar distance is such that:
P+d=(D+nT)tan(θ), in which θ is the tilt angle of the supports with respect to the tracks, T is the longitudinal pitch of the head gaps of pairs of polar parts placed on a given support, D is the longitudinal offset with respect to supports between two pairs of consecutive polar parts placed on two consecutive supports, and P is the width of polar parts and n is an integer number.

43. A recording and/or read device according to claim 40, further comprising a magnetic shielding and/or magnetoresistive read means inserted between the two supports in a space corresponding to the inter-polar part distance.

44. A recording and/or read device according to claim 40, wherein the azimuth angle and the tilt angle are equal in modulus.

45. A recording and/or read device according to claim 40, wherein the azimuth angle and the tilt angle are different.

46. A recording and/or read device according to claim 40, comprising at least two consecutive supports at different tilt angles.

47. A recording and/or read device according to claim 46, wherein the azimuth angles of the head gaps of the pairs of polar parts of one of the supports are different from the azimuth angles of the pairs of polar parts of the other support.

48. A recording and/or read device according to claim 46, wherein two pairs of polar parts belonging to different supports cooperate with two consecutive magnetic tracks to read them or record them.

49. A recording and/or read device according to claim 40, comprising at least one block of at least one support for recording and at least one block of at least one support for reading, these blocks being placed one after the other in the direction of the tracks.

50. A recording and/or read device according to claim 40, comprising at least one block of one or plural supports for recording and at least one block of one or plural supports for reading, the supports of these blocks being fixed to each other.

51. A recording and/or read device according to claim 40, wherein each track is recorded and read by a pair of polar parts, the pair of polar parts for recording and the pair of polar parts for reading belonging to different supports.

52. A recording and/or read device according to claim 49, wherein a block for reading is separated from a block for recording by a shielding screen.

53. A recording and/or read device according to claim 40, comprising, for each magnetic head, a magnetic circuit integrating a pair of polar parts and optionally a magnetic flux guide, this magnetic circuit cooperating with recording and/or read means.

54. A recording and/or read device according to claim 53, wherein the recording and/or read means and the magnetic flux guide, if there is one, for each magnetic head are on an additional support that is assembled with the support supporting the pairs of polar parts of the magnetic head.

55. A recording and/or read device according to claim 53, wherein the recording and/or read means are inductive or magnetoresistive.

56. A recording and/or read device according to claim 40, wherein signal processing means cooperate with recording and/or read means.

57. A method of making a device for recording and/or reading on a magnetic recording medium with magnetic tracks, comprising:
on plural substrates producing plural pairs or polar parts of magnetic heads, these polar parts being separated by an amagnetic head gap, the head gaps of these pairs of polar parts on a particular substrate all having the same azimuth angle between ±90° excluding limits from a direction normal to the substrate:
assembling the substrates by superposing the substrates so as to define between two consecutive substrates a non-zero inter-polar part distance, which is the distance between face planes facing the polar parts located on the two supports;
producing recording and/or read means and optionally magnetic flux guides each configured to cooperate with a pair of polar parts; and
treating the substrates such that they have a non-zero tilt angle from the magnetic tracks equal to between ±90°.

58. A method according to claim 57, wherein the recording and/or read means and magnetic flux guides, if any, are made on at least one additional substrate that is assembled after positioning with the substrate supporting the pairs of polar parts with which they cooperate.

59. A method according to claim 58, wherein the recording and/or read means and possibly magnetic flux guides, if any, are made on the substrate supporting the pairs of polar parts.

60. A method according to claim 57, wherein the treating grinds at the substrates.

61. A method according to claim 57, wherein the treating installs at least one part of the substrate or the substrate in a given mechanical support.

62. A method according to claim 57, wherein the substrates supporting pairs of polar parts are assembled after alignment.

63. A method according to claim 62, wherein a layer of electrically insulating material is inserted between two consecutive substrates supporting pairs of polar parts, this layer optionally including magnetoresistive read means and/or a magnetic shielding screen.

64. A method according to claim 62, wherein shims are inserted between two consecutive substrates supporting the pairs of polar parts.

65. A method according to claim 57, making pairs of magnetic connection pads, on one of the substrates, each used to magnetically connect a flux guide or a recording means and/or a read means to a pair of polar parts supported on an identical or a different substrate.

66. A method according to claim 58, wherein the two substrates are assembled after turning one of the substrates over.

67. A method according to claim 57, wherein at least one substrate is thinned.

68. A method according to claim 57, wherein substrates supporting pairs of polar parts have different tilt angles.

69. A method according to claim 68, wherein the azimuth angle of the head gaps of the pairs of polar parts of one substrate is different from the azimuth angle of the head gaps of the pairs of polar parts of the other substrate.

70. A method according to claim 57, wherein a pair of polar parts is made by anisotropically etching a first caisson in the substrate, forming an amagnetic layer on the substrate, filling the first caisson with magnetic material, isotropically etching a second caisson adjacent to the first caisson, and filling the second caisson with magnetic material.

71. A method according to claim 70, wherein to obtain the pairs of magnetic pads, pairs of caissons are made by isotropic etching in the substrate that hold the pairs of magnetic pads and the pairs of caissons are filled with a magnetic material.

72. A method according to claim 70, wherein the surface is levelled after any one of the magnetic material filling has been done.

73. A method according to claim 70, wherein the substrate supporting pairs of polar parts is formed from an electrically insulating material located between two layers, in which the layer supporting the caissons is monocrystalline, the other optionally being partially or totally eliminated at a later time.

74. A method according to claim 73, wherein the substrate supporting pairs of polar parts is formed from an electrically insulating material located between a layer of wear resistant material and a layer of monocrystalline material comprising the caissons.

75. A method according to claim 58, wherein the assembly is made by gluing, by direct bonding, by anodic assembly, or by fusible bumps.

76. A method according to claim 58, wherein the additional substrate within which the recording and/or read means are located, and the magnetic flux guides, if any, include a layer made from a wear resistant material possibly covered by an electrically insulating material.

77. A method according to claim 58, wherein the additional substrate within which the recording and/or read means are located, and the magnetic flux guides, if any, include a layer made from a wear resistant material possibly covered by an electrically insulating material.

78. A method according to claim 57, further comprising making signal processing means that cooperate with the recording and/or read means.
